(19) United States
(12) Patent Application Publication
(10) Pub. No.: US 2019/0089241 A1
(43) Pub. Date: Mar. 21, 2019

(54) Reconfigurable Bidirectional DC-AC Power Inverter for Worldwide Voltages

(71) Applicant: The Government of the United States of America ,as represented by the Secretary of the Navy, Arlington, VA (US)

(72) Inventor: Daniel Opila, Bethesda, MD (US)

(21) Appl. No.: 15/711,171

(22) Filed: Sep. 21, 2017

(51) Int. Cl. H02M 1/42; H02M 7/02

(52) U.S. Cl. CPC H02M 1/4216; B60L 11/1809; H02M 7/02

(57) ABSTRACT

Systems and method are provided for using a single reconfigurable alternating current (AC)/direct current (DC) voltage converter to support a three phase mode and a single phase mode for multiple worldwide voltages. In an embodiment, one leg of a DC/DC converter can be repurposed for AC operation in single-phase mode. This repurposing provides two parallel bridges for each AC connection and will roughly double the available AC current, leading to a more efficient voltage converter that better uses components of the voltage converter.

### FIELD OF THE DISCLOSURE

This disclosure relates to voltage converters, including AC/DC voltage converters.

### BACKGROUND

Because of varying power specifications around the world, alternating current to direct current (AC/DC) converters for worldwide deployment or multiple applications are often required to operate with single-phase or three-phase AC connections at a variety of voltages, currents, and single-phase or multi-phase connections, as these parameters can vary depending on the country and charging type.

Many devices used for mobile or worldwide applications must be able to connect to single and three-phase connections at various voltages when the device moves or when the device is deployed to a different country. Manufacturers would much prefer a single converter for worldwide deployment. A common example is laptop power supplies, which are used worldwide with only a plug change. Electric vehicle chargers are a higher-power application with both single and three phase connections.

AC-DC Converters designed to handle three-phase inputs can be easily used with single-phase connections by simply neglecting one phase, but this method is a generally a poor solution and reflects a typical design problem of optimizing for multiple operating points. Existing voltage converters are generally optimized for one type of input and are under-utilized for different charging conditions. For example, with respect to converters used for electric vehicle charging, a typical AC/DC converter optimized for a 400V 3-phase European connection will only produce about 35% of rated power when operating on a 240V single phase connection in North America. Further, existing designs often use a 2-level topology for converters. These existing designs have inefficiencies and underutilize sonic converter components.

### BRIEF DESCRIPTION OF THE DRAWINGS/FIGURES

The accompanying drawings, which are incorporated in and constitute part of the specification, illustrate embodiments of the disclosure and, together with the general description given above and the detailed descriptions of embodiments given below, serve to explain the principles of the present disclosure. In the drawings:

FIG. 1A is a diagram showing an AC/DC converter operating in a three-phase configuration;

FIG. 1B is a diagram showing an AC/DC converter operating in a single-phase configuration;

FIG. 2A is a diagram showing an AC/DC converter operating in a three-phase configuration in accordance with an embodiment of the present disclosure;

FIG. 2B is a diagram showing an AC/DC converter operating in a single-phase configuration in accordance with an embodiment of the present disclosure;

FIG. 3A is a diagram showing a double pole, double throw (DPDT) automatic switching configuration that can be used with the single-phase mode converter of FIG. 2B in accordance with an embodiment of the present disclosure;

FIG. 3B is a diagram showing an adapter plug for three-phase use that can be used with the three-phase mode converter of FIG. 2A in accordance with an embodiment of the present disclosure;

FIG. 3C is a diagram showing an adapter plug for single-phase use that can be used with the single-phase mode converter of FIG. 2B in accordance with an embodiment of the present disclosure;

FIG. 4 is a diagram showing results for three-phase operation at low voltages of a prototype in accordance with an embodiment of the present disclosure;

FIG. 5A is a diagram showing phase legs of an AC/DC converter in accordance with a three phase AC connection embodiment of the present disclosure;

FIG. 5B is a diagram showing phase legs of an AC/DC converter in accordance with a single phase AC connection embodiment of the present disclosure; and

FIGS. 6A and 6B are diagrams showing a converter with reconfigurable phase legs in accordance with an embodiment of the present disclosure.

Features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

In the following description, numerous specific details are set forth to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of this discussion, the term “module” shall be understood to include one of software, or firmware, or hardware (such as circuits, microchips, processors, or devices, or any combination thereof), or any combination thereof. In addition, it will be understood that each module can include one, or more than one, component within an actual device, and each component that forms a part of the described module can function either cooperatively or independently of any other component forming a part of the module. Conversely, multiple modules described herein can represent a single component within an actual device. Further, components within a module can be in a single device or distributed among multiple devices in a wired or wireless manner.

### 1. Overview

In accordance with embodiments of the present disclosure, an AC/DC converter can be reconfigured to support worldwide power requirements, while enabling more efficient utilization of converter components than is present in conventional converters.

Existing designs often use a 2-level topology and underutilize converter components. For example, if a conventional European 400V 3-phase AC/DC converter is rated for 100% power, a typical design using 240V single phase power will only produce about 35% of rated power (240/400* \sqrt{3}) in North America. The 240V single phase of an AC/DC converter in accordance with embodiments of the present disclosure can produce about 70% of the 400V three-phase rated power, roughly double the single-phase power available with a conventional topology. Assuming the limiting factor is the DC side switches, the reduced power rating (66%) is well-matched to the incoming AC power.

In accordance with an embodiment of the present disclosure, some of the DC side switches can be repurposed when operating in single-phase mode. Normally, in single phase operation, one of the AC switch branches would be completely unused, and the DC side branches would be under-utilized because of the decreased power from the AC side. In accordance with embodiments of the present disclosure, one of the DC side switches can be used to make 4 AC side branches for a single phase system. With common worldwide voltages, the missing DC side branch is not needed.

For example, an AC/DC converter in accordance with an embodiment of the present disclosure can be constructed with two back-to-back 3-phase 2-level bridges. When operating in single phase mode, the DC side is under-utilized, so one of those phase legs can be reconnected to the unused AC phase to have two parallel single phase connections and approximately double the throughput power. A single converter in accordance with an embodiment of the present disclosure can produce much more power at a variety of voltages, advantageously enabling manufacturers, automakers, etc., to produce a single part for global use.

### 2. Single-Phase Use of a Three-Phase Converter

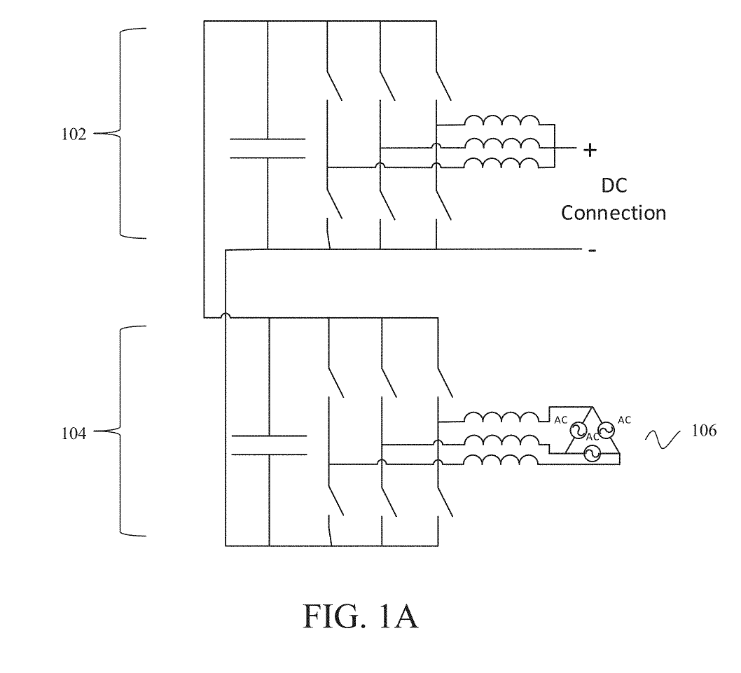

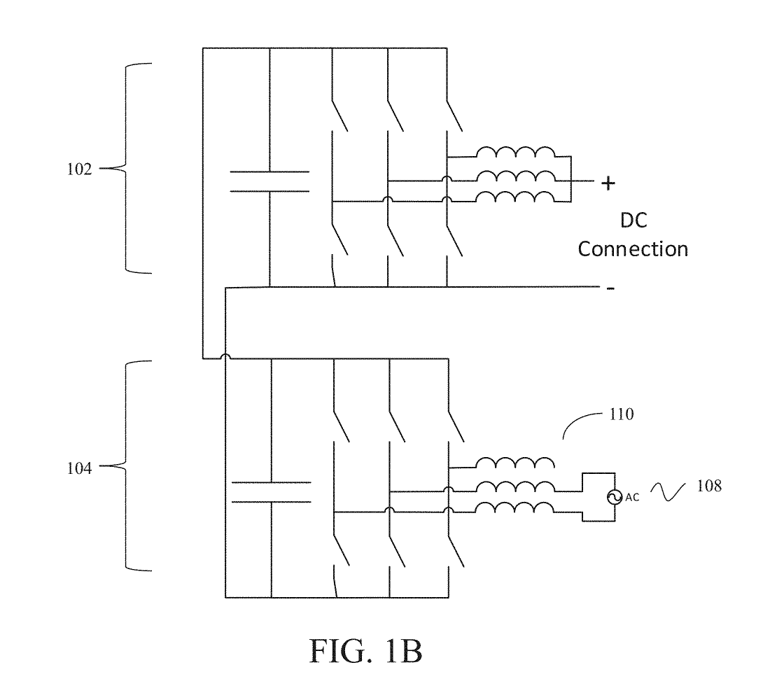

FIGS. 1A and 1B are diagrams of an AC/DC converter designed to handle three-phase inputs that can also be used with a single-phase connection. Specifically, FIG. 1A shows the converter operating in a three phase configuration, and FIG. 1B shows the converter operating in a single-phase configuration. The converter of FIGS. 1A and 1B can be manufactured from two identical 3-phase 2-level bridges to maximize part commonality.

The converter of FIG. 1A has a DC stage 102 and an AC stage 104. AC stage 104 is configured to he connected to an AC grid (e.g., through a wall plug). As discussed above, the converter of FIG. 1A is configured to operate in a three-phase configuration, so all three wires of AC stage 104 are coupled to the AC grid 106 in FIG. 1A. The converter of FIG. 1B is configured to operate in a single-phase configuration. When AC stage 104 of the converter of FIG. 1B is coupled to AC grid 108, there is an extra unused wire 110.

A common application for the converter of FIGS. 1A and 1B is a bidirectional inverter/rectifier for a DC source or load with a minimum voltage below the rectification limit of the maximum AC voltage. Typical examples include an electric vehicle (EV) battery charging/discharging unit with bidirectional power flow, a microgrid battery, or a solar inverter. For a nominal case, the DC voltage ranges from 280-400V and the charger may connect to a variety of worldwide voltages including 480, 400, or 208V three phase, and 120, 220, or 240V single phase.

While this range of application voltages would lend itself to specially designed converters for each voltage or at least each country, manufacturers want to minimize part variations as much as possible, especially in relatively low-volume products. A challenging design is a converter for the Level 2 EV charging common in both the US and Europe, as shown in Table 1.

TABLE 1
Common global EV charging methods for Level 2

| Connector | Voltage | Current | Power |
|---|---|---|---|
| IEC62196 (Europe) | 400 V 3 ph | 32 A | 22.1 kW |
| SAE J1772 (US) | 240 V 1 ph | 80 A | 19.2 kW |

The similar output power ratings might imply that a single converter could serve both purposes. We assume the converter is designed for the European 3-phase 32A version and the AC bridge is current limited regardless of voltage. As discussed above, when operating on the single phase 240V case at the same 32A, it only produces 35% of the rated power. Similarly, if designed for the 80A input, the three-phase variant is oversized. The same issues appear for Level 3 charging applications with 3-phase 600, 480, or 208V, but these applications often assume the converter will be off-board the vehicle and thus have a fixed voltage.

### 3. Reconfigurable Converter for Single-Phase and Three-Phase Applications

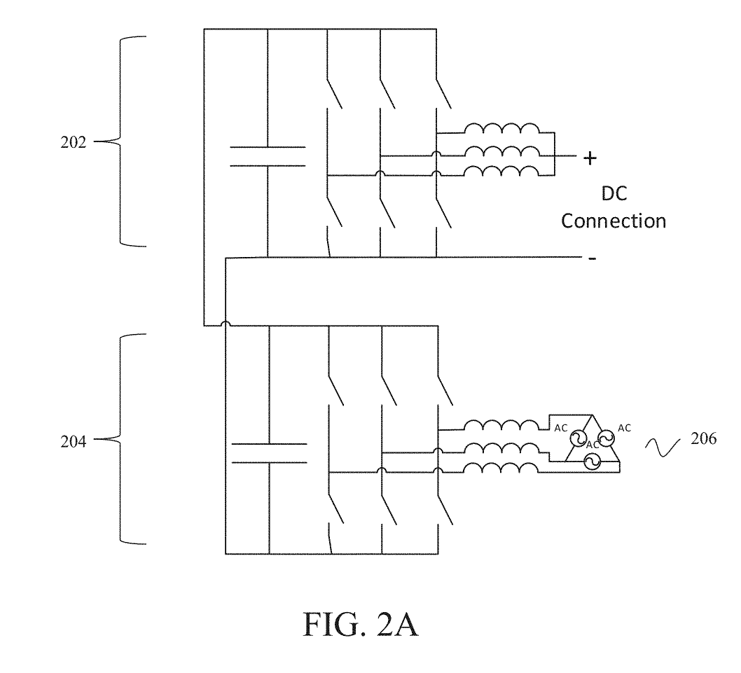

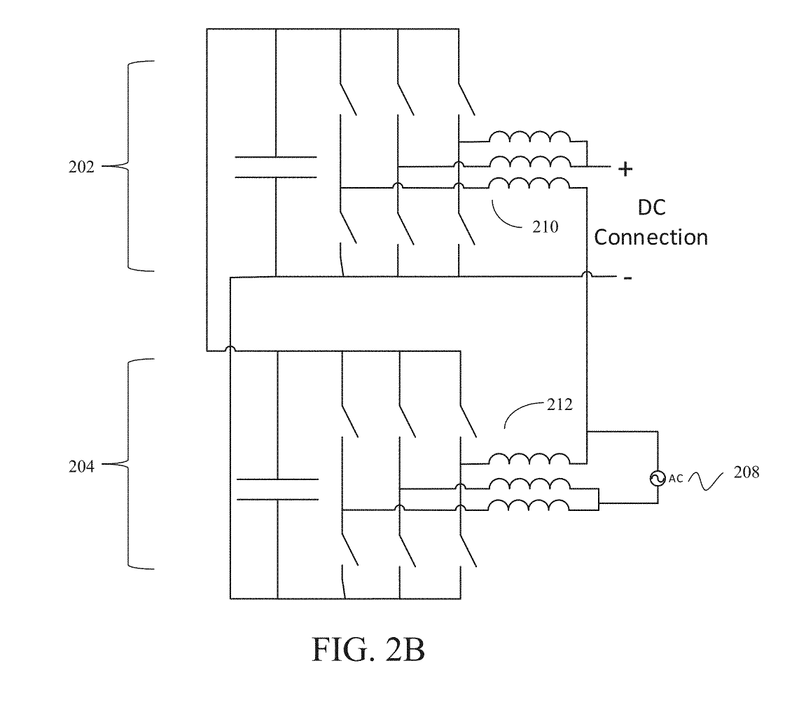

As discussed above, when single-phase mode of FIG. 1B is used, the DC/DC converter is underutilized. FIGS. 2A and 2B show a reconfigurable converter for single-phase and three-phase applications in accordance with an embodiment of the present disclosure that better utilizes the DC/DC converter in single-phase mode. Specifically, the converter of FIG. 2A has a DC stage 202 and an AC stage 204. AC stage 204 is configured to be connected to AC grid 206. The converter of FIG. 2B is configured to operate in a single-phase configuration.

Assuming the devices and inductors are of similar construction to the AC side, one leg 210 of the DC/DC converter of FIG. 1B can be re-purposed for AC operation in single-phase mode as shown in FIG. 2B by coupling it to the extra wire 212 of AC stage 204. This provides two parallel bridges for each AC connection and will roughly double the available AC current.

In an embodiment, the reconfiguration of FIG. 2B to re-purpose one leg of the DC/DC converter 210 involves changing some AC and DC output connections. This can occur with an automated double pole, double throw (DPDT) no-load switch, an adapter plug for single or three-phase use, or a jumper installed in the factory based on the desired application. In an embodiment, a semi-permanent and/or factory reconfiguration can use jumpers to support the reconfiguration of FIG. 2B to re-purpose one leg of the DC/DC converter 210.

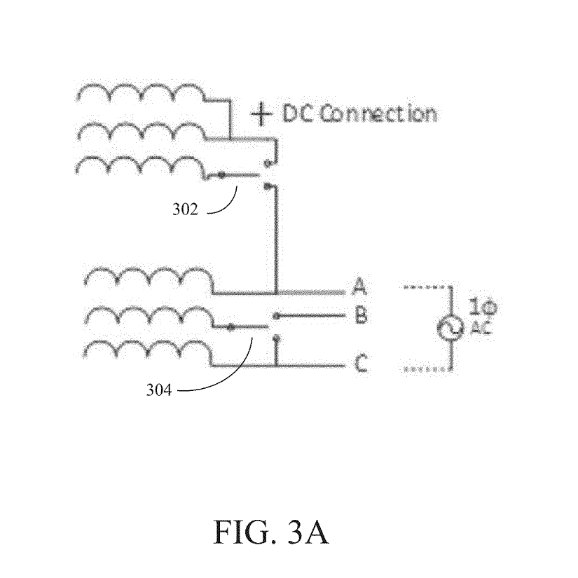

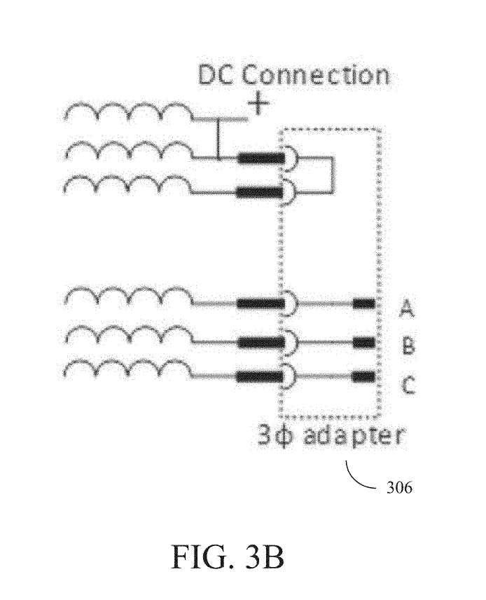

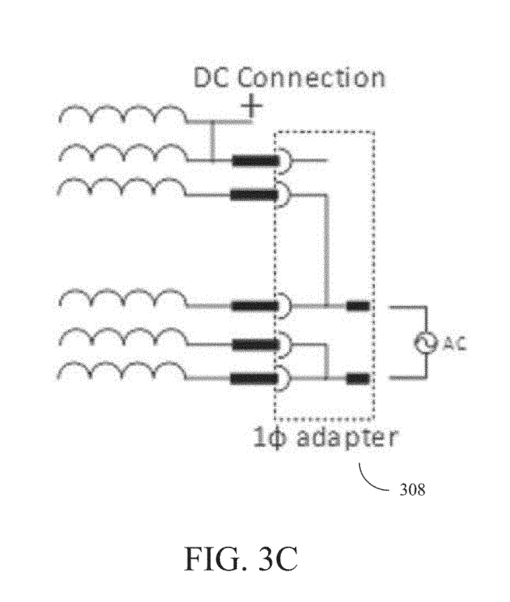

FIG. 3A is a diagram showing a DPDT automatic switching configuration that can be used with the single-phase mode converter of FIG. 2B. As shown in FIG. 3A, switch 302 can be coupled to the bottom inductor of DC stage 202 of FIG. 2B, and switch 304 can be coupled to the middle inductor of AC stage 204 of FIG. 2B to implement automated DPDT switching. For example, in an embodiment, in a three-phase mode, switch 302 can be toggled to couple the bottom inductor of DC stage 202 to the middle inductor of DC stage 202, and switch 304 can be toggled to couple the middle inductor of AC stage 204 to node B of FIG. 3A. In an embodiment, in a single-phase mode, switch 302 can be toggled to couple the bottom inductor of DC stage 202 to the top inductor of AC stage 204 (and to node A of FIG. 3A), and switch 304 can be toggled to couple the middle inductor of AC stage 204 to node C of FIG. 3A.

FIG. 3B is a diagram showing an adapter plug for three-phase use that can be used with the three-phase mode converter of FIG. 2A. As shown in FIG. 3B, three-phase adapter 306 can be coupled to the inductors of DC stage 202 and AC stage 204 of FIG. 2A to support three-phase operation.

FIG. 3C is a diagram showing an adapter plug for single-phase use that can be used with the single-phase mode converter of FIG. 2B. As shown in FIG. 3C, single-phase adapter 308 can be coupled to the inductors of DC stage 202 and AC stage 204 of FIG. 2B to support single-phase operation.

In an embodiment, similar hardware layouts can be used for AC and DC stages 102, 104, 202, and 204 to make a bidirectional converter. In an embodiment, switches shown in FIGS. 1A, 1B, 2A, 2B, and 3A-3C contain antiparallel diodes. In an embodiment, DC stages 102 and 202 can be made using 3 legs, as shown in FIGS. 1A-3C, or fewer if desired. In an embodiment, if the converter is only unidirectional (inverter or active rectifier), some components can be removed from DC stages 102 and 202.

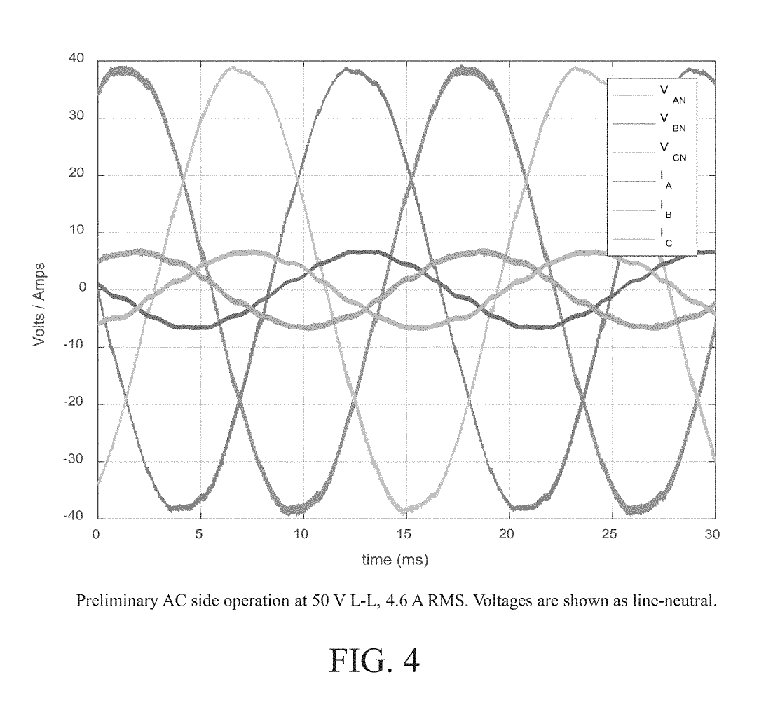

Under typical design conditions, the DC/DC converter supported by DC stages 102 and 202 has lower losses than the AC side supported by AC stages 103 and 204 and thus can be run at higher switching frequency to improve DC side ripple or decrease DC load capacitance. Let us assume the worst case, that under nominal 3-phase rated conditions (100% power), the DC bridge is thermally limited. Removing one DC/DC leg would yield 66% of rated power on that converter stage. Running single phase AC at the same line voltage would normally decrease the AC rated power by 1/\sqrt{3} to 58%. The two stages are well-matched, and the third DC leg is generally not required in this configuration. However, the single-phase voltage is often significantly less than the 3-phase version. For the 240/400 V example case, the single phase power would then only be 35% of rated power. Using the extra DC phase leg on the AC side, this input current doubles, and the AC side produces 70% of rated power, which is now a good match to the 2-leg DC side. FIG. 4 is a diagram showing results for three-phase operation at low voltages of a prototype designed to operate at three-phase 208V 5A maximum, and, after reconfiguration, 10A 120V single phase.

The reconfigurable converter topology in accordance with embodiments of the present disclosure can use standard bridges, switching technology, and 2 stage AC/DC DC/DC design but allows a much wider range of application voltages using the reconfiguration(s) discussed above. Reconfigurable converters in accordance with embodiments of the present disclosure can use common parts for both the inverter and DC/DC stages. Thus, by using the systems and methods of the present disclosure, many existing converter designs could extend their operating range using the adjustments discussed herein. An application example was discussed above with reference to electric vehicle charging, but many applications could benefit from the single-phase and three-phase reconfigurations of the present disclosure.

### 4. Reconfiguring Phase Legs of Converter

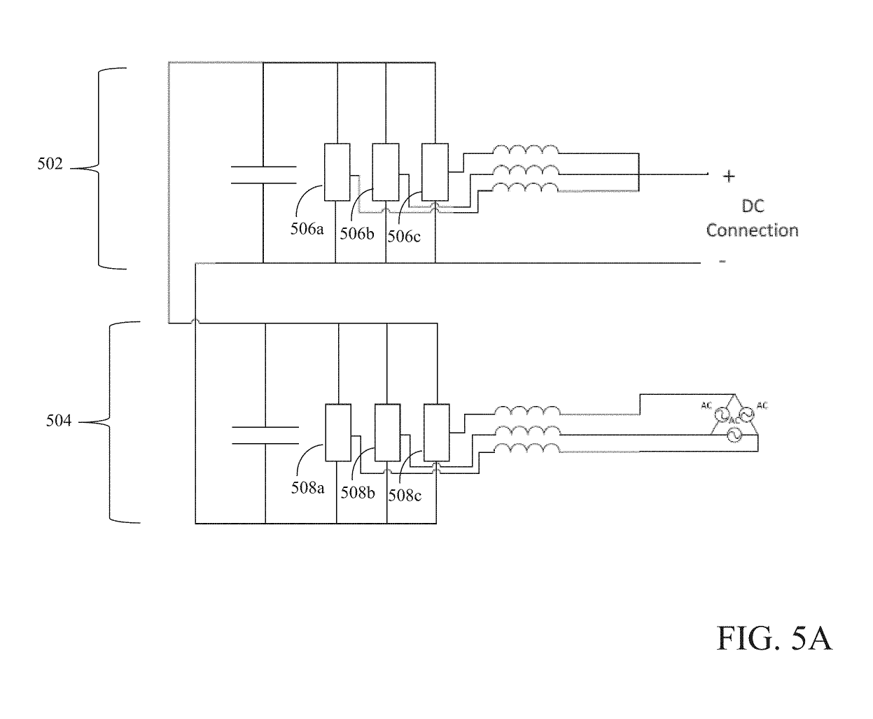

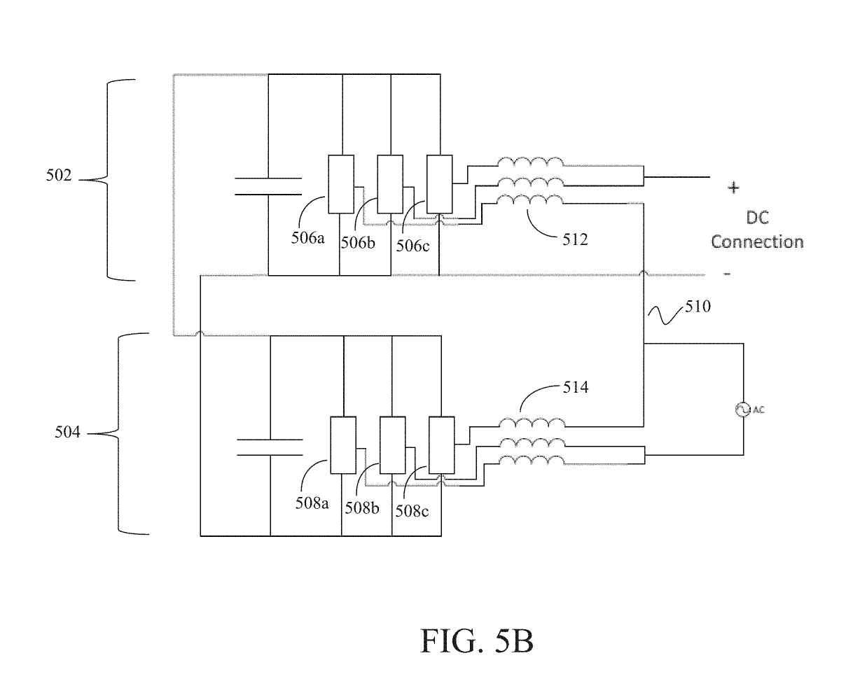

FIG. 5A is a diagram showing phase legs of an AC/DC converter in accordance with a three phase AC connection embodiment of the present disclosure, Specifically, the converter of FIG. 5A has a DC stage 502 and an AC stage 504. The DC stage 502 of FIG. 5A comprises phase legs 506a, 506b, and 506c. The AC stage 504 of FIG. 5A comprises phase legs 508a, 508b, and 508c.

FIG. 5B is a diagram showing phase legs of an AC/DC converter in accordance with a single phase AC connection embodiment of the present disclosure. In FIG. 5B, one phase leg of the DC stage 502 is repurposed for AC operation in single-phase mode. For example, in FIG. 5B, phase leg 506a of DC stage 502 is repurposed for AC operation by creating a new connection 510 between phase leg 506a and AC stage 504 (e.g., between inductors 512 and 514). In accordance with an embodiment of the present disclosure, any of phase legs 506 or 508 can be repurposed, e.g., via switches or other coupling mechanisms, to operate on either the AC or DC side of the AC/DC converter of FIG. 5A (e.g., depending on the operating point of each phase leg).

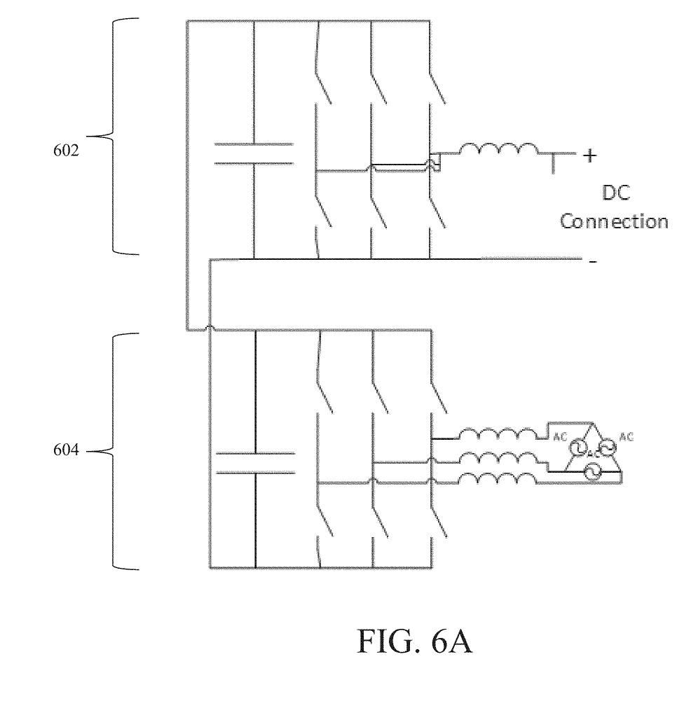

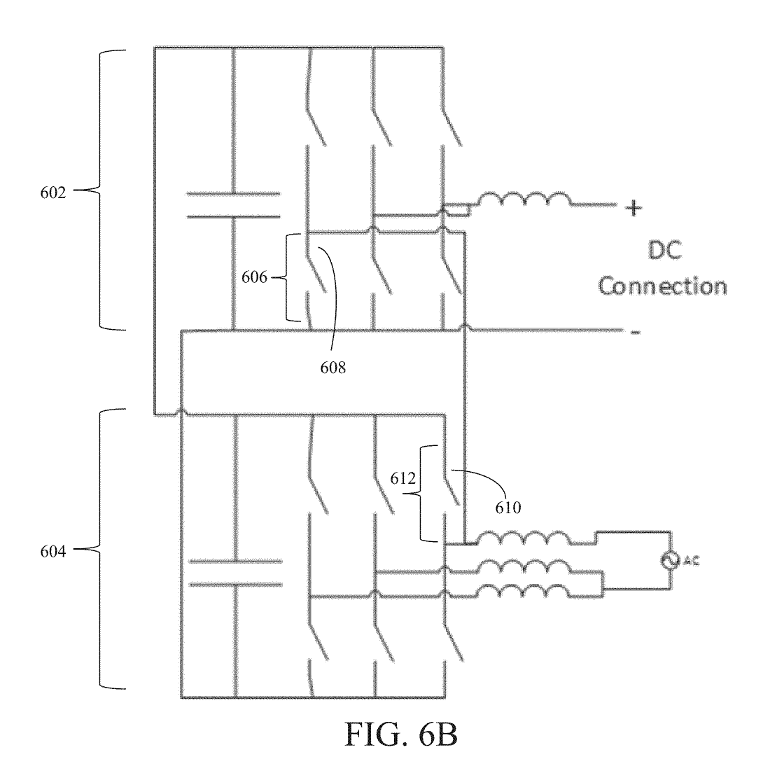

FIGS. 6A and 6B are diagrams showing a converter with reconfigurable phase legs in accordance with an embodiment of the present disclosure. Specifically, the converter of FIG. 6A has a DC stage 602 and an AC stage 604. As shown in FIG. 6B, a phase leg 606 of the DC stage 602 of FIG. 6B can be re-purposed for AC operation in single-phase mode by coupling it (e.g., using switch 608 and switch 610) to a phase leg 612 of AC stage 604. This provides two parallel bridges for each AC connection and will roughly double the available AC current. Further, as shown in FIG. 6B, repurposing phase legs does not necessarily require repurposing inductors (or other components), which can advantageously lead to savings on cost and total part count.

### 5. Conclusion

It is to be appreciated that the Detailed Description, and not the Abstract, is intended to be used to interpret the claims. The Abstract may set forth one or more but not all exemplary embodiments of the present disclosure as contemplated by the inventor(s), and thus, is not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Any representative signal processing functions described herein can be implemented using computer processors, computer logic, application specific integrated circuits (ASIC), digital signal processors, etc., as will be understood by those skilled in the art based on the discussion given herein. Accordingly, any processor that performs the signal processing functions described herein is within the scope and spirit of the present disclosure.

The above systems and methods may be implemented as a computer program executing on a machine, as a computer program product, or as a tangible and/or non-transitory computer-readable medium having stored instructions. For example, the functions described herein could be embodied by computer program instructions that are executed by a computer processor or any one of the hardware devices listed above. The computer program instructions cause the processor to perform the signal processing functions described herein. The computer program instructions (e.g., software) can be stored in a tangible non-transitory computer usable medium, computer program medium, or any storage medium that can be accessed by a computer or processor. Such media include a memory device such as a RAM or ROM, or other type of computer storage medium such as a computer disk or CD ROM. Accordingly, any tangible non-transitory computer storage medium having computer program code that cause a processor to perform the signal processing functions described herein are within the scope and spirit of the present disclosure.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments.

1. A voltage converter, comprising:
a direct current (DC) to DC stage, comprising a first plurality of phase legs including a first phase leg; and
a DC to alternating current (AC) stage, comprising a second plurality of phase legs, including;
a second phase leg, wherein the first phase leg is configured to be coupled to the second phase leg such that the coupling between the first and second phase legs forms a first parallel bridge enabling the first phase leg to be configured to support operation in a single phase AC mode,
a third phase leg, and
a fourth phase leg, coupled to the third phase leg, wherein the coupling between the third and fourth phase legs forms a second parallel bridge configured to support operation in the single phase AC mode.

2. The voltage converter of claim 1, wherein the DC to DC stage further comprises an inductor coupled to the first phase leg, and wherein the coupling between the first and second phase legs enables the inductor to support operation in the single phase AC mode.

3. (canceled)

4. The voltage converter of claim 1, further comprising:
a first switch configured to couple the first phase leg to the second phase leg or to disconnect the first phase leg from the DC to DC stage; and
a second switch configured to couple the second phase leg to an AC grid or to the first phase leg and the AC grid.

5-20. (canceled)

21. A voltage converter, comprising:
a direct current (DC) to DC stage, comprising:
a first plurality of phase legs including a first phase leg, and
a first inductor coupled to the first phase leg; and
a DC to alternating current (AC) stage, comprising a second plurality of phase legs, including;
a second phase leg, wherein the first phase leg is configured to be coupled, via the first inductor, to the second phase leg such that the coupling between the first and second phase legs forms a first parallel bridge enabling the first phase leg to be configured to support single phase AC power operation,
a third phase leg, and
a fourth phase leg, coupled to the third phase leg, wherein the coupling between the third and fourth phase legs forms a second parallel bridge configured to support single phase AC power operation.

22. The voltage converter of claim 21, wherein the DC to AC stage further comprises:
a second inductor connected to the second phase leg, wherein a connection between the first inductor and the second inductor enables the first phase leg to be used for single phase AC power operation.

23. The voltage converter of claim 22, wherein the DC to DC stage further comprises:
a third inductor coupled to the first phase leg; and
a fourth inductor coupled to the first phase leg.

24. The voltage converter of claim 22, wherein the DC to AC stage further comprises:
a fifth inductor coupled to the second phase leg; and
a sixth inductor coupled to the second phase leg.

25. (canceled)

26. (canceled)

27. The voltage converter of claim 21, wherein the first phase leg is coupled to the second phase leg during a single phase mode.

28. The voltage converter of claim 21, wherein the first phase leg is not coupled to the second phase leg during a three-phase mode.

29. The voltage converter of claim 27, wherein the first phase leg is coupled to an AC grid in the single phase mode, and wherein the first phase leg is coupled to a DC connection in a three-phase mode.

30. The voltage converter of claim 21, further comprising:
a plug adapter coupled to the first phase leg and the second phase leg to support single phase AC power operation.

31. A voltage converter configured to operate in a single phase alternating current (AC) mode or a three-phase AC mode, the voltage converter comprising:
a direct current (DC) to DC stage, comprising a first plurality of phase legs including a first phase leg, wherein the first plurality of phase legs are coupled to an input of a DC load or a DC source; and
a DC to AC stage, comprising a second plurality of phase legs including;
a second phase leg, wherein the first phase leg is configured to be coupled to the second phase leg such that the coupling between the first and second phase legs forms a first parallel bridge enabling the first phase leg to be configured to support operation in the single phase AC mode,
a third phase leg, and
a fourth phase leg coupled to the third phase leg, wherein the coupling between the third and fourth phase legs forms a second parallel bridge configured to support operation in the single phase AC mode.

32. The voltage converter of claim 31, wherein the first phase leg is not coupled to the second phase leg during the three-phase AC mode.

33. The voltage converter of claim 31, wherein the second phase leg is coupled to an AC grid in the three-phase AC mode, and wherein the first phase leg is coupled to a DC connection in the three-phase AC mode.

34. The voltage converter of claim 31, further comprising:
a plug adapter coupled to the first phase leg and the second phase leg to support the three-phase AC mode.

35. The voltage converter of claim 1, wherein the DC to DC stage further comprises:
a fifth phase leg connected to a first inductor, wherein the first inductor is connected to a DC load; and
a sixth phase leg, connected to a second inductor, wherein the second inductor is connected to the DC load.

36. The voltage converter of claim 1, wherein the first phase leg is connected to the fifth phase leg and the sixth phase leg.

37. The voltage converter of claim 1, wherein the DC to DC stage is a DC to DC voltage converter configured to convert a DC input to a DC output.

38. The voltage converter of claim 1, wherein the DC to AC stage is a DC to AC voltage converter configured to convert the DC output to an AC output.

39. The voltage converter of claim 31, wherein the DC to AC stage further comprises:
a first AC grid input and a second AC grid input, wherein, in the single phase AC mode, the first parallel bridge is connected to the first AC grid input and the second parallel bridge is connected to the second AC grid input.
